(19) United States
(12) Patent Application Publication
(10) Pub. No.: US 2024/0267414 A1
(43) Pub. Date: Aug. 8, 2024

(54) NETWORK-BOUNDARY CONVERGED MULTI-LEVEL SECURE COMPUTING SYSTEM

(71) Applicant: Adam Gruen Krellenstein, Manchester, NH (US)

(72) Inventor: Adam Gruen Krellenstein, Manchester, NH (US)

(21) Appl. No.: 18/426,916

(22) Filed: Jan. 30, 2024

Related U.S. Application Data
(60) Provisional application No. 63/483,616, filed on Feb. 7, 2023.

(51) Int. Cl. H04L 9/40

(52) U.S. Cl. CPC H04L 63/20

(57) ABSTRACT

A hybrid converged multi-level secure (MLS) computing system includes a plurality of independent computers configured to run one or more applications, each running a separate operating system and having its own security policies. A system may include a thin-client device connected to the independent computers over a computer network. A system may include a desktop compositor running on the thin-client device, configured to composite the applications running on the independent computers into a unified user interface. A system may include a combination of multi-function network protocols and desktop-/screen-sharing software running on the independent computers and the thin-client device, configured to enable communication between the thin-client device and each of the independent computers.

### INCORPORATION BY REFERENCE TO ANY PRIORITY APPLICATIONS

The present application claims the benefit of U.S. Provisional Patent Application No. 63/483,616, filed Feb. 7, 2023, and titled A NETWORK-BOUNDARY CONVERGED MULTI-LEVEL SECURE COMPUTING SYSTEM, which is incorporated herein by reference in its entirety under 37 C.F.R. § 1.57. Any and all applications for which a foreign or domestic priority claim is identified in the Application Data Sheet as filed with the present application are hereby incorporated by reference under 37 CFR 1.57.

### BACKGROUND

There is a critical need for more secure computing systems. Increasing dependence on digital technology and interconnected systems has elevated the importance of computing systems with built-in security measures. As society becomes more digitized, the volume and sensitivity of data being transmitted and stored electronically have surged, making these systems attractive targets for malicious actors. Cybersecurity threats such as data breaches, ransomware attacks, and identity theft have become more sophisticated and prevalent. Without robust security measures, individuals and organizations face the risk of financial losses, reputational damage, and the compromise of important systems.

A compelling response to these cybersecurity challenges lies in the adoption of converged multi-level secure (MLS) computing systems. These integrated platforms allow users to operate across distinct security domains through a single user interface (UI). Traditional MLS systems rely on hardware-level isolation using a keyboard-video-mouse (KVM) switch and no UI compositing or more recently with software-level isolation and software-based UI compositing (e.g., using a hypervisor). While hardware-level isolation is theoretically much more secure than software-level isolation, the overall usability of any MLS system without user-interface compositing is necessarily poor in comparison, because there is no single, unified interface provided for the user.

The software-level isolation present in the prior art integrates user interfaces across various domains onto a single desktop interface. However, these software-level isolation techniques rely on large trusted computing bases to run the hypervisor, the security domain software, and the drivers, increasing the complexity of the necessary trusted computing base and increasing risk from compromised hardware.

Recently, a system for hardware-level isolation with hardware-based UI compositing was developed, but the usability of even this design is still much lower than that of those with software-based compositing because all interfaces between the security domains must be implemented in silico. Certain technologies allow users to access multiple isolated networks from a single thin client but have no capability for user-interface compositing.

Improved hardware isolation-based multi-level secure computing systems would increase computing system security by reducing reliance on software-level security systems while allowing a clean user interface through effective UI compositing.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a network-boundary converged multi-level secure computing system is described. The system includes: a plurality of independent computers configured to run one or more applications, each running a separate operating system and having its own security policies; a thin-client device connected to the independent computers over a computer network; a desktop compositor running on the thin-client device, configured to composite the applications running on the independent computers into a unified user interface; and a combination of multi-function network protocols and desktop-/screen-sharing software running on the independent computers and the thin-client device, configured to enable communication between the thin-client device and each of the independent computers.

In some embodiments, the system further comprises multi-function network protocols and desktop-/screen-sharing software running on the independent computers and the thin-client device are further configured to enable communication among the independent computers.

In some embodiments, the system further comprises a case for the independent computers, allowing them to be handled as a single desktop or portable computer; a shared power supply for the independent computers; and a networking switch connecting the independent computers and the thin-client device.

In some embodiments, the system further comprises a software-defined network (SDN) which allows for communication among the independent computers and the thin client over wide-area networks (WANs) such as the Internet. In some embodiments, the system comprises multi-function network protocols which include one or more of: Secure Shell (SSH), Telnet, Remote Desktop Protocol (RDP), File Transfer Protocol (FTP), and HTTP/HTTPS. In some embodiments, the system comprises multi-function network protocols which include one or more of: Virtual Network Computing (VNC), Team Viewer, NoMachine, X Windows System, SPICE, Citrix, Remote Desktop Service (RDS), VMWare Horizon, and AnyDesk.

In some embodiments, at least one of the independent computers are connected to the Internet via a router. In some embodiments, at least one of the independent computers are connected to the Internet via at least one of a cellular or a satellite modem.

In some embodiments, the thin-client device includes a laptop running a minimal operating system. In some embodiments, the system comprises independent computers which are single-board computers (SBC).

In some embodiments, the system comprises independent computers which are enclosed in one or more Faraday Cages. In some embodiments, the system comprises independent computers which are isolated from each other with acoustic or vibration damping material.

In some embodiments, the system comprises traffic analysis mitigation software installed on one or more of the components of the system.

In some embodiments, the system comprises a firewall running on one or more of the devices of the system, configured to protect the thin-client device from malicious network traffic and/or to enforce data information flow policies. In some embodiments, the independent computers are configured to run applications with different levels of access to system resources. In some embodiments, the system resources include one or more of memory, storage, or processing power. In some embodiments, the independent computers are configured to run applications with different levels of access to network resources. In some embodiments, the network resources include bandwidth and/or external connectivity.

In some embodiments, the system further includes a security manager running on the thin-client device, configured to enforce security policies across the independent computers and the thin-client device. In some embodiments, the system further includes a configuration manager running on the thin-client device, configured to manage the configuration of the independent computers and the thin-client device.

In some embodiments, the system further includes a monitoring agent running on the thin-client device, configured to monitor the performance and status of the independent computers and the thin-client device. In some embodiments, the monitoring agent is configured to take one or more actions based on the performance and status. In some embodiments, the actions taken by the monitoring agent include one or more of: quitting an application, restarting a network interface, or rebooting a device.

In some embodiments, the system includes a provisioning system running on the thin-client device or one of the independent computers, configured to provision new independent computers and configure them for use in the system. In some embodiments, the system further includes a system for key exchange between the independent computers and the thin client. In some embodiments, the system further includes a system for secure cryptographic authentication between the independent computers and the thin client.

In some embodiments, the techniques described herein relate to a method for providing hardware-level isolation 1, including: running a separate operating system and security policies on each of the independent computers; connecting the independent computers to a network using multi-function network protocols and desktop-sharing software; compositing the applications running on the independent computers into a single user interface on the thin-client device; and enabling communication between the independent computers and the thin-client device through the network using the multi-function network protocols and desktop-sharing software.

In some embodiments, the system described herein comprises a computer program product for providing hardware-level isolation 1.

### BRIEF DESCRIPTION OF THE DRAWINGS

FIG. 1 is a block diagram of an example embodiment of a hardware-isolated multi-level secure computing system.

FIG. 2 is a block diagram of an example embodiment of a hardware-isolated multi-level secure computing system.

FIG. 3 is a block diagram of an example embodiment of a hardware-isolated multi-level secure computing system.

### DETAILED DESCRIPTION

We introduce a new, hybrid design which performs software-based user-interface compositing with hardware-level isolation using standard network interfaces. We can relegate each security domain to an independent headless computer, each with its own application state and security policies. These application servers can be networked together (e.g., over a LAN) and accessible by the user through a thin-client device that is connected to the same network. The applications running on the various application servers are composited within a single user interface running on the thin client using a combination multi-function network protocols (such as SSH) and desktop-sharing software (such as VNC over SSL).

Instead of having to trust an operating system to be able properly to isolate different security domains all running on shared hardware, our design relies on cryptographically secure networking protocols to connect multiple independent computers together to form a single, virtual device that from the user's perspective functions very much like a normal desktop computer. Instead of running multiple virtual machines on a single computer (whether to save costs or to isolate different security domains at the level of a hypervisor) we instead merge together multiple computers into a single virtual machine, where the actual hardware that any given application runs on (for security, or, for that matter, for performance) can be abstracted away. This provides for the best of both words: the security guarantees of hardware isolation plus the usability and flexibility of interfaces implemented in software.

Such a system may be built exclusively with commercial off-the-shelf (COTS) hardware, and the trusted computing base (TCB) of the system can be limited to the codebase for the networking protocols (SSH, etc.), which may be both widely used and easily audited.

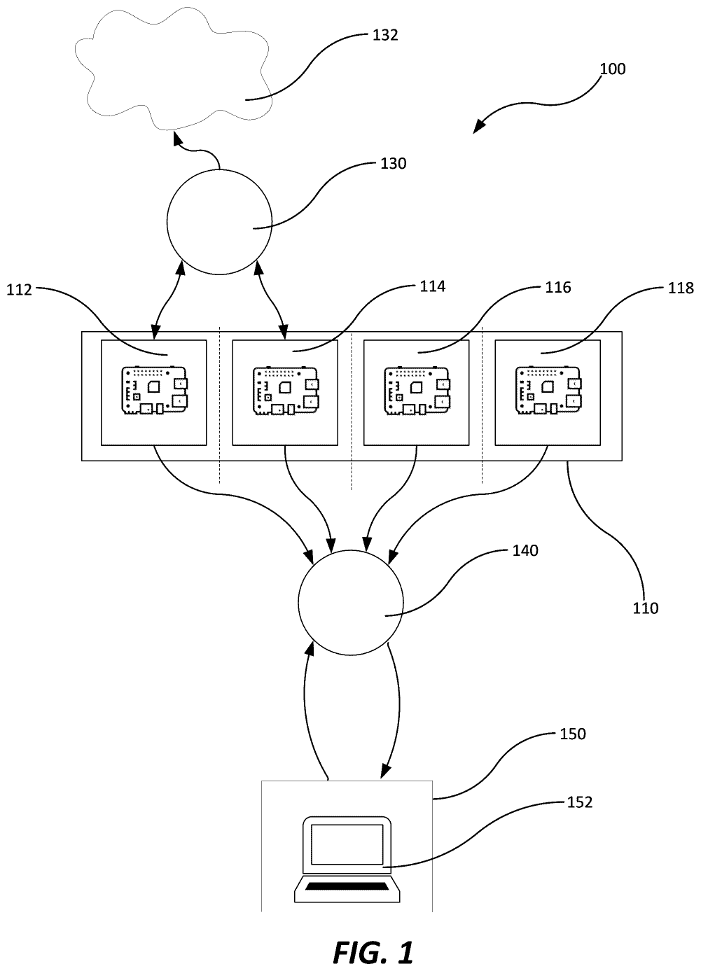

FIG. 1 illustrates an example embodiment of a hardware-isolated multi-level secure computing system 100 that may be used to implement the networked computing systems disclosed herein, in accordance with certain embodiments. Example computing system 100 comprises computer bank 110, networking switch 140, and thin-client device 152.

Computer bank 110 is comprised of a plurality of independent computers 112, 114, 116, and 118 that serve as application servers. Each independent computer (112, 114, 116, and 118) runs its own application state and security policies, being assigned a security domain. Each independent computer can run whichever user applications are allowed within the security domain associated with the device in question. For example, independent computer 112 might run a web browser, independent computer 114 might run an email application, independent computer 116 might run office tools applications, while independent computer 118 might run a password manager. Some of the independent computers are connected with an external network, i.e., for increased functionality in running certain applications. Here, independent computers 112 and 114 are connected to the internet 132 via a router 130 to enable independent computer 112 to run a web browser and independent computer 114 to run an email application.

As shown by the dotted lines in between the independent computers in computer bank 110, each independent computer (i.e., independent computer 114) is isolated from the other independent computers (i.e., independent computers 112, 116, and 118). This allows each independent computer to run its own application state and security policies without needing to juggle multiple security policies such as a traditional software-level-isolated MLS computing system through a hypervisor and/or security domain management software.

Each independent computer in computer bank 110 is connected via networking switch 140 to the thin-client device 152, which receives the applications running on the independent computers through virtual machine 150. Networking switch 140 comprises an ethernet switch to which the independent computers of computer bank 110 are connected via cable. The thin-client device 152 runs a desktop compositor software application combining the independent computer outputs into a single user interface. Through that user interface, the user can interact with the applications hosted on independent computers 112, 114, 116, and 118.

Because independent computers 112, 114, 116, and 118 are running the application software, thin-client device 152 can depend on the remote server capabilities of computer bank 110 and needs only limited local processing. A compositor on thin-client device 152 combines the information received from independent computers 112, 114, 116, and 118 into a single virtual machine 150 with a unified user interface.

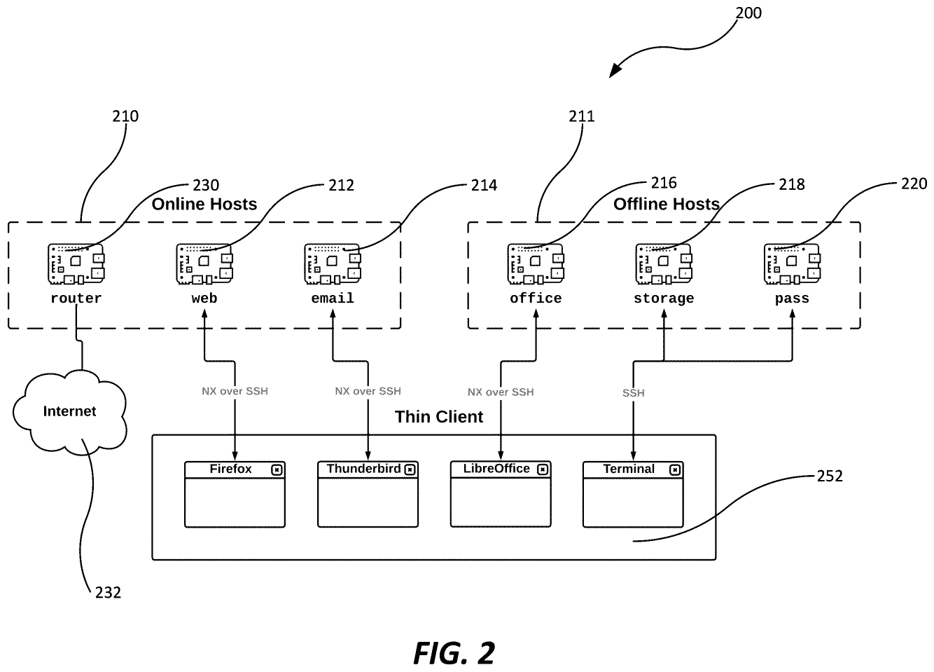

FIG. 2 illustrates an example embodiment of a hardware-isolated multi-level secure computing system 200 that may be used to implement the networked computing systems disclosed herein, in accordance with certain embodiments. Computing system 200 comprises online computer bank 210, offline computer bank 211, and thin-client device 250.

Online computer bank 210 comprises independent computer 212, independent computer 214, and router 230. Independent computer 212 and independent computer 214 are connected to the internet 232 via router 230. This allows independent computer 212 and independent computer 214 to host online applications. These online applications hosted by the independent computers of online computer bank 210 are accessible to the user from the thin-client device 252 using a virtual desktop software over a secure networking protocol. For example, independent computer 212 hosts Firefox, a web browser application. Independent computer 214 hosts Thunderbird, an email application. Independent computer 212 and independent computer 214 access the internet 232 via router 230, allowing the independent computers to run these applications.

Offline computer bank 211 comprises independent computer 216, independent computer 218, and independent computer 220. These independent computers are not connected to an outside network such as the internet 232, but instead host offline applications. For example, independent computer 216 hosts Libreoffice, an office productivity software application.

The applications hosted by the independent computers of online computer bank 210 and offline computer bank 211 are accessible to the user via thin-client device 252. Each independent computer communicates with the thin-client device 252 using a combination of multi-function network protocols (here, SSH) and desktop-sharing software (here, NX or NoMachine). The information feed from each independent computer (212, 214, and 216) are composited together by software on the thin-client device 252 to form a single virtual machine.

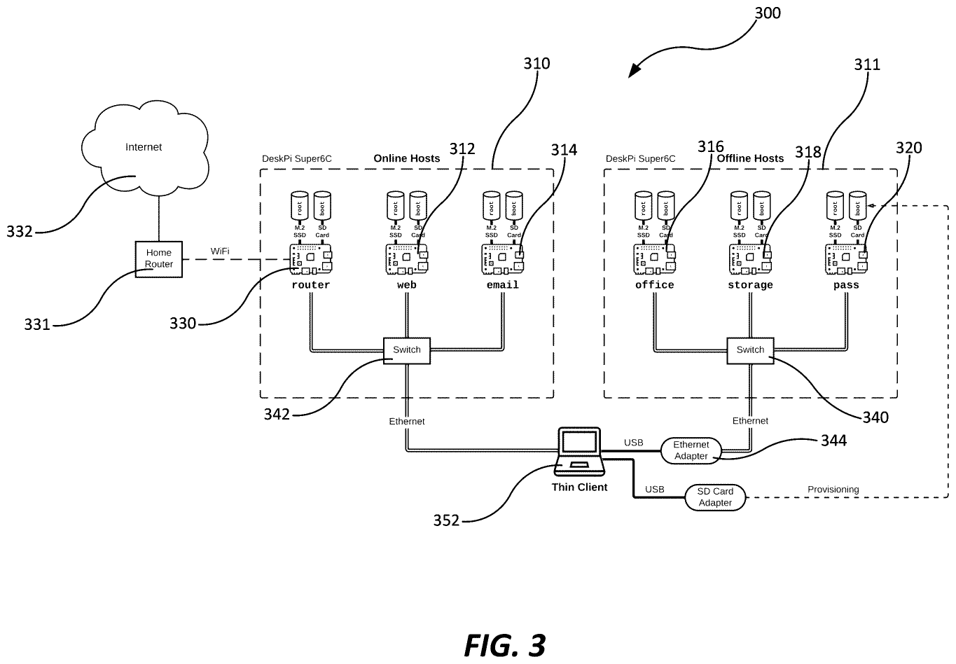

FIG. 3 illustrates an example embodiment of a hardware-isolated multi-level secure computing system 300 that may be used to implement the networked computing systems disclosed herein, in accordance with certain embodiments. Computing system 300 comprises online computer bank 310, offline computer bank 311, and thin-client device 352.

Online computer bank 310 comprises independent computers 312 and 314. Each independent computer runs its own application state and security policies, being assigned a security domain. Each independent computer can run whichever user applications are allowed within the security domain associated with the device in question. Online computer bank 310 comprises an independent computer that functions as a router 330. Router 330 connects to an external network such as the internet 332 through home router 331 over Wi-Fi. Independent computers 312 and 314 connect with router 330 via ethernet cable and network switch 342, allowing these independent computers to host internet-required applications such as a web browser or email application.

Offline computer bank 311 similarly comprises several independent computers. These independent computers (316, 318, and 320) each run its own application state and security policies, being assigned a security domain. Independent computers 316, 318, and 320 host offline applications such as computer storage and office software.

Independent computers 312, 314, 316, 318, and 320 each utilize a secure network protocol such as SSH to send and receive communications. At least independent computers 312, 314, and 316 may also use a remote access protocol to enable screen remote desktop/screen-sharing use. The independent computers are connected with external storage devices such as SSD and SD cards, which store system files and directories for startup, executing applications, and managing security settings.

The independent computers of online computer bank 310 are connected with a thin-client device 352 via ethernet switch 342 and ethernet cable. The independent computers of offline computer bank 311 are connected with the thin-client device 352 via ethernet switch 340, ethernet cable, and an ethernet-to-USB adaptor 344. This ethernet-to-USB adaptor 344 allows use of a thin-client device 352 with only one ethernet port.

Thin-client device 352 sends and receives information from independent computers 312, 314, 316, 318, and 320 over a secure network protocol. A compositor process on thin-client device 352 combines the information received from the independent computers into a single user interface.

Independent computers 312 and 314 and router 330 of online computer bank 310 can be contained on a cluster board, such as the DeskPi Super6c, for ease of transportation. In some embodiments, the cluster board containing computer bank 310 can be contained in a case. Similarly, independent computers 316, 318, and 320 of offline computer bank 311 can be contained on a cluster board, such as the DeskPi Super6c, for ease of transportation.

In some embodiments, independent computers comprise single-chip computers such as Raspberry Pi computers. These computers are sufficiently small that the computer bank comprising the independent computers can be stored together in a transportable case, using a shared power supply. In some embodiments, one or more independent computers comprise Mac mini computers. In some embodiments, one or more independent computers comprise smartphones. In some embodiments, one or more independent computers comprise

Intel or AMD NUC computers. In some embodiments, one or more independent computers comprise single-board computers using ARM or RISC-V architectures.

In some embodiments, one or more independent computers run Raspberry Pi OS operating systems. In some embodiments, one or more independent computers run macOS operating systems. In some embodiments, one or more independent computers run Android operating systems. In some embodiments, one or more independent computers run Linux operating systems. In some embodiments, one or more independent computers run Free BAD operating systems. In some embodiments, one or more independent computers run Windows operating systems.

In some embodiments, one or more independent computers may have removable storage. In some embodiments, the removable storage is a solid-state drive. In some embodiments, the removable storage is provided by SD cards.

In some embodiments, the independent computers are held in a case for easing transportation and storage.

In some embodiments, at least one independent computer functions as a multi-function networking protocol server, implementing and managing the network protocol.

In some embodiments, the at least one independent computer initiates and accepts secure communication using a secure or cryptographic network protocol. In some embodiments, the cryptographic network protocol is OpenSSH.

In some embodiments, at least one independent computer functions as a remote desktop/screen-sharing server. In some embodiments, the at least one independent computer functioning as a remote desktop/screen-sharing server facilitates remote access through a specific remote access protocol. In some embodiments, the remote access protocol is Virtual Network Computing (VNC). In some embodiments, the remote access protocol is X Remote Desktop Protocol (xrdp). In some embodiments, the remote access protocol is Wayland. In some embodiments, the remote access protocol is Remote Desktop Protocol (RDP). In some embodiments, the remote access protocol is NoMachine (NX protocol). In some embodiments, these protocols are used through applications or implementations such as Remmina, Wayvnc, Rustdesk, NoMachine, etc.

In some embodiments, at least one independent computer is protected by full-disk encryption. In some embodiments, the at least one independent computer thus protected is accessed with a security key.

In some embodiments, at least one independent computer is powered via an individual power supply. In some embodiments, at least two independent computers are powered via a shared power supply. In some embodiments, at least one independent computer is powered over an interface such as USB.

In some embodiments, at least one independent computer is configured to run user applications such as an email application, a web browser, or a word processing application.

In some embodiments, at least one independent computer is protected from side-channel attack mitigations. In some embodiments, this protection is provided by at least one Faraday cage shielding the at least one independent computer from electromagnetic signals and/or radiation. In some embodiments, this protection is provided by sound baffling between the independent computers and/or between at least one independent computer and the outside environment.

In some embodiments, the thin-client device used to access the applications running on the independent computers is a computer with input and display devices. In some embodiments, the thin-client device is a laptop. In some embodiments, the thin-client device is a desktop. In some embodiments, the thin-client device is a tablet. In some embodiments, the thin-client device is a smartphone. In some embodiments, thin-client device runs a minimal operating system with an SSH client, a VNC client, and a desktop compositor.

In some embodiments, the thin-client device facilitates remote access through a remote desktop/screen-sharing client. In some embodiments, the thin-client device initiates and accepts secure communication using a secure or cryptographic network protocol client. In some embodiments, the cryptographic network protocol is OpenSSH. In some embodiments, the thin-client device operates a multi-function network protocol client. In some embodiments, the thin-client device operates a compositor component or process configured to combine and render graphical elements from the at least one independent computers into a single user interface.

In some embodiments, networking hardware is configured to connect the at least one independent computer to the thin-client device. In some embodiments, the networking hardware includes networking cables. In some embodiments, the networking hardware includes a networking switch. In some embodiments, the networking switch is an ethernet switch. In some embodiments, the networking switch is a Wi-Fi switch.

In some embodiments, networking hardware is configured to connect at least one independent computer to an external network. In some embodiments, the external network is the internet. In some embodiments, the networking hardware includes a router for internet access. In some embodiments, the multi-level secure computing system comprises a firewall implementing a managed information flow policy.

In some embodiments, one or more application servers (e.g., Raspberry Pi computers) can include two network interfaces (e.g., two Ethernet ports, Ethernet and Wi-Fi, or dual Wi-Fi). In some embodiments, one network interface can be used for connectivity to the client (e.g., laptop or other thin client) and the other interface may be used for connectivity to an external network, such as the internet. In some embodiments, one or more application servers may have a single network interface, or a second network interface may disabled. Such application servers may not be connected to the internet, and the single interface may be used for connectivity to the client. In some embodiments, a system can include a second switch. The second switch can be used to manage connections to external networks, such as the internet, such that a computing system designed according to the present disclosure may have external network connectivity via a single ethernet port, as opposed to each application server with network connectivity using a separate port on a router.

The security properties of this design compare favorably to those of software-boundary multi-level secure systems. First and foremost, such solutions rely on a large trusted computing base, including not only the (very complex) hypervisor, but also much of the underlying hardware (also very complex) The network boundary is an ideal security boundary because it was historically designed explicitly for the interconnection of independent devices, often with different security policies. Both the hardware interface and the software compositing layer are small and well-understood. In some embodiments, the only data being pushed to the thin client are pixels. In some embodiments, clipboard data can be pushed to the thin client. In some embodiments, audio streams can be pushed to the thin client from the application servers. In some embodiments, data are never communicated directly from application server to application server. As a consequence, so long as the user of the thin client doesn't explicitly pull malware onto the device, for example with SSH, via a web browser, etc., the risk of compromising the thin client (and by extension, the application servers) can practically-speaking be limited to the risk of critical input validation errors in the screen-sharing software itself or at the level of the network drivers. That is, even if the UI compositor on the thin-client machine does not enforce any security boundaries between application windows, the primary attack surface is limited to the application actually running in those windows, i.e. the screen-sharing software, e.g. VNC.

The state-of-the-art in secure computing systems is Qubes OS.6 Qubes OS is an open source converged multi-level secure operating system that uses hardware virtualization (with Xen) to isolate security domains. There is a number of major weaknesses inherent in the design of Qubes OS, all of which stem from the fact that it has a very large TCB. First, Qubes OS relies heavily on the security guarantees of Xen, which is large, complicated, and has a history of serious security vulnerabilities. Second, Qubes OS relies on the security properties of the hardware it runs on. Third, the complexity inherent in the design of Qubes OS makes the operating system difficult both to maintain and to use. Accordingly, Qubes OS development has slowed significantly in recent years: as of December 2022, the last release (v4.1.x, in February 2022) came almost four years after the previous one (v4.0.x in March 2018). Finally, Qubes OS has support only for extremely few hardware configurations. As of December 2022, are only three laptops that are known to be fully comply with Qubes

A pure network-boundary converged multi-level secure computing system, as described herein, can be simultaneously simpler, more secure and more user-friendly than Qubes OS. Indeed, this design addresses many of the major problems with QubesOS. It has the following advantages:

With the design in question, there can be a wide range of choice of hardware for the thin client and for each of the application servers. Most any modern operating system may be used on any of the devices, as long as it supports the standard network interfaces required for SSH, etc. This flexibility can enable the system to run a wide variety of software without being limited to a particular operating system. For example, different application servers can run different operating systems depending upon the user's needs. For example, one may run a Linux-based operating system, while another may run FreeBSD (for example for providing network-attached storage), while yet another may run Windows (for example, to enable access to desktop versions of popular office or creative applications).

### Additional Embodiments

In a first embodiment, a network-boundary converged multi-level secure computing system is described. The system includes: a plurality of independent computers configured to run one or more applications, each running a separate operating system and having its own security policies; a thin-client device connected to the independent computers over a computer network; a desktop compositor running on the thin-client device, configured to composite the applications running on the independent computers into a unified user interface; and a combination of multi-function network protocols and desktop-/screen-sharing software running on the independent computers and the thin-client device, configured to enable communication between the thin-client device and each of the independent computers.

In a second embodiment, the system further comprises multi-function network protocols and desktop-/screen-sharing software running on the independent computers and the thin-client device are further configured to enable communication among the independent computers.

In a third embodiment, the system further comprises a case for the independent computers, allowing them to be handled as a single desktop or portable computer; a shared power supply for the independent computers; and a networking switch connecting the independent computers and the thin-client device.

In a fourth embodiments, the system further comprises a software-defined network (SDN) which allows for communication among the independent computers and the thin client over wide-area networks (WANs) such as the Internet. In some embodiments, the system comprises multi-function network protocols which include one or more of: Secure Shell (SSH), Telnet, Remote Desktop Protocol (RDP), File Transfer Protocol (FTP), and HTTP/HTTPS. In some embodiments, the system comprises multi-function network protocols which include one or more of: Virtual Network Computing (VNC), Team Viewer, NoMachine, X Windows System, SPICE, Citrix, Remote Desktop Service (RDS), VMWare Horizon, and AnyDesk.

In a fifth embodiment, at least one of the independent computers are connected to the Internet via a router. In some embodiments, at least one of the independent computers are connected to the Internet via at least one of a cellular or a satellite modem.

In a sixth embodiment, the thin-client device includes a laptop running a minimal operating system. In a seventh embodiment, the system comprises independent computers which are single-board computers (SBC).

In an eighth embodiment, the system comprises independent computers which are enclosed in one or more Faraday Cages. In a ninth embodiment, the system comprises independent computers which are isolated from each other with acoustic or vibration damping material.

In a tenth embodiment, the system comprises traffic analysis mitigation software installed on one or more of the components of the system.

In an eleventh embodiment, the system comprises a firewall running on one or more of the devices of the system, configured to protect the thin-client device from malicious network traffic and/or to enforce data information flow policies. In a twelfth embodiment, the independent computers are configured to run applications with different levels of access to system resources. In some embodiments, the system resources include one or more of memory, storage, or processing power. In some embodiments, the independent computers are configured to run applications with different levels of access to network resources. In some embodiments, the network resources include bandwidth and/or external connectivity.

In a thirteenth embodiment, the system further includes a security manager running on the thin-client device, configured to enforce security policies across the independent computers and the thin-client device. In some embodiments, the system further includes a configuration manager running on the thin-client device, configured to manage the configuration of the independent computers and the thin-client device.

In a fourteenth embodiment, the system further includes a monitoring agent running on the thin-client device, configured to monitor the performance and status of the independent computers and the thin-client device. In some embodiments, the monitoring agent is configured to take one or more actions based on the performance and status. In some embodiments, the actions taken by the monitoring agent include one or more of: quitting an application, restarting a network interface, or rebooting a device.

In a fifteenth embodiment, the system includes a provisioning system running on the thin-client device or one of the independent computers, configured to provision new independent computers and configure them for use in the system. In some embodiments, the system further includes a system for key exchange between the independent computers and the thin client. In some embodiments, the system further includes a system for secure cryptographic authentication between the independent computers and the thin client.

In a sixteenth embodiment, the system enables a method for providing hardware-level isolation 1, including: running a separate operating system and security policies on each of the independent computers; connecting the independent computers to a network using multi-function network protocols and desktop-sharing software; compositing the applications running on the independent computers into a single user interface on the thin-client device; and enabling communication between the independent computers and the thin-client device through the network using the multi-function network protocols and desktop-sharing software.

In some embodiments, the system described herein comprises a computer program product for providing hardware-level isolation 1.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A system for providing hardware-level isolation of security domains, comprising:
a plurality of independent computers configured to run one or more applications, each running a separate operating system and having its own security policies;
a thin-client device connected to the independent computers over a computer network;
a desktop compositor running on the thin-client device, configured to composite the applications running on the independent computers into a unified user interface; and
a combination of multi-function network protocols and desktop-/screen-sharing software running on the independent computers and the thin-client device, configured to enable communication between the thin-client device and each of the independent computers.

2. The system of claim 1, wherein the combination of multi-function network protocols and desktop-/screen-sharing software running on the independent computers and the thin-client device are further configured to enable communication among the independent computers.

3. The system of claim 1, further comprising:
a case for the independent computers, allowing them to be handled as a single desktop or portable computer;
a shared power supply for the independent computers; and
a networking switch connecting the independent computers and the thin-client device.

4. The system of claim 1, wherein a software-defined network (SDN) allows for communication among the independent computers and the thin-client device over wide-area networks (WANs) such as Internet.

5. The system of claim 1, wherein the multi-function network protocols comprise one or more of Secure Shell (SSH), Telnet, Remote Desktop Protocol (RDP), File Transfer Protocol (FTP), or HTTP/HTTPS.

6. The system of claim 1, wherein the multi-function network protocols comprise one or more of Virtual Network Computing (VNC), Team Viewer, NoMachine, X Windows System, SPICE, Citrix, Remote Desktop Service (RDS), VMWare Horizon, or AnyDesk.

7. The system of claim 1, wherein at least one of the independent computers are connected to Internet via a router.

8. The system of claim 1, wherein at least one of the independent computers are connected to the Internet via at least one of a cellular or a satellite modem.

9. The system of claim 1, wherein the thin-client device comprises a laptop running a minimal operating system.

10. The system of claim 1, wherein the independent computers are single-board computers (SBC).

11. The system of claim 1, wherein the independent computers are enclosed in one or more Faraday Cages.

12. The system of claim 1, wherein the independent computers are isolated from each other with acoustic or vibration damping material.

13. The system of claim 1, wherein traffic analysis mitigation software is installed on one or more of the independent computers.

14. The system of claim 1, further comprising a firewall running on one or more of the devices of the system, configured to protect the thin-client device from malicious network traffic and/or to enforce data information flow policies.

15. The system of claim 1, wherein the independent computers are configured to run applications with different levels of access to system resources.

16. The system of claim 15, wherein the system resources comprise one or more of memory, storage, or processing power.

17. The system of claim 1, wherein the independent computers are configured to run applications with different levels of access to network resources.

18. The system of claim 17, wherein the network resources comprise one or more of bandwidth or external connectivity.

19. A method for providing hardware-level isolation of security domains using a system as described in claim 1, comprising:
running a separate operating system and security policies on each of the independent computers;
connecting the independent computers to a network using multi-function network protocols and desktop-sharing software;
compositing the applications running on the independent computers into a single user interface on the thin-client device; and
enabling communication between the independent computers and the thin-client device through the network using the multi-function network protocols and desktop-sharing software.

20. A computer program product for providing hardware-level isolation of security domains, comprising a computer-readable storage medium having computer-executable instructions for performing a method as described in claim 1.
